(19) United States
(12) Patent Application Publication
(10) Pub. No.: US 2006/0089246 A1
(43) Pub. Date: Apr. 27, 2006

(54) Versatile paper folder

(75) Inventors: George Arthur Carver, Wabash, IN (US); Andrew Robert Koselke, Wabash, IN (US)

Correspondence Address: ANDREW R. KOSELKE, 603 N. WALNUT STREET, ETNA GREEN, IN, 46524, US

(73) Assignee: MARTIN YALE INDUSTRIES, INC.

(21) Appl. No.: 10/973,581

(22) Filed: Oct. 26, 2004

(51) Int. Cl. B31F 1/10

(52) U.S. Cl. 493/434

(57) ABSTRACT

A versatile paper folder provides the folding of paper of any size within the pre-determined range into half-fold, letter fold, z-fold, double parallel fold, and brochure fold. There are two paper stop drive assemblies of similar construction, each providing for the automatic positioning of the respective paper stops. In both paper stop drive assemblies, a potentiometer provides an electronic feedback to a microprocessor on the current position of a belt with the paper stop. The microprocessor then activates a motor that moves the belt with the paper stop to a new position defined by the user input. The automatically-adjustable paper stops require the input from a user on the type of fold and paper, but not the user's intervention in the adjustment of the paper stops.

### TECHNICAL FIELD

The technical field of this disclosure is the paper folders, particularly, the versatile paper folders having means for the adjustment for different paper sizes and fold styles.

### BACKGROUND OF THE INVENTION

Paper folders are used to fold a sheet of paper into sections in order to fit this sheet into an envelope. Typically, folders use a set of rollers to grab and move paper being folded through the folding process, and crease the paper as it passes between sets of contacting rollers. In the majority of cases, folders would only create one or two folds. Versatile paper folders could fold a sheet of paper into two sections in one fold, or three or four sections in two folds. The most common folds are: half-fold, letter fold, z-fold, double parallel fold, and brochure fold.

Folds in paper are made by blocking the path of the paper with the barrier commonly known as a paper stop. Together with the paper stop, the paper must be loosely contained within what is commonly known as a fold table. As the paper leaves the set of rollers, it enters into the fold table. Within the fold table, at a predetermined distance from the rollers, there is the paper stop. When the paper strikes the paper stop, because the paper is contained within the fold table, the only place that the paper can buckle is outside of the fold table, near the rollers, at the entrance of the fold table. An additional set of rollers will then capture the paper at the buckle and finish the fold by creasing the paper as the paper passes through the set of rollers. By changing the relative distance between the paper stop and the rollers, the position of the fold will also change.

In addition to being capable to produce different folds, the contemporary paper folder is required to accommodate various paper standards. The most common paper standards are letter size, legal size, and A4 European standard. However, the truly versatile paper folder is required to accommodate any size within the pre-defined range. In order to accommodate for all these variations, two adjustable paper stops are required, one for each fold.

For example, in the EP0511574A1, Manfred Fuss discloses a buckle folder with one or more folding pockets each having its own paper stop that can be adjusted to the different length.

In the U.S. Pat. No. 5,180,357 Joseph H. Marzullo discloses a folding machine with the paper stops adjustable with the dual rack and pinion arrangement accessible from the side of the machine.

In the above folders, as in the other folders with the adjustable stops, each time the folder configuration is changed, the position of the paper stop in the fold table needs to be adjusted to produce the desired fold. Even though this works quite well, a degree of user experience is required to configure the paper stops for different types of fold or different paper sizes.

It would be desirable to have a folder with the automatically-adjustable paper stops. Such a folder would require the input from a user on the type of fold and paper, but not the user's intervention in the adjustment of the paper stops.

### SUMMARY OF THE INVENTION

The object of this invention is to provide a versatile paper folder capable of folding paper of any size within the pre-determined range into any conventionally used two-or-three section fold, or double parallel four section fold.

Another object of this invention is providing a paper folder with the automatically-adjustable paper stops that does not require the user's intervention in the adjustment of the paper stops.

According to this invention, a first paper stop drive assembly provides for the automatic positioning of a first paper stop, the first paper stop providing for the first fold, and a second paper stop drive assembly provide for the automatic positioning of a second paper stop, the second paper stop providing for the second fold. In each paper stop drive assembly, a potentiometer provides an electronic feedback to a microprocessor on the current position of a belt with the paper stop, then the microprocessor activates a motor that moves the belt with the paper stop to a new position defined by the user input.

### BRIEF DESCRIPTION OF THE FIGURES

FIG. 1 is a perspective view of the versatile paper folder of the present invention.

FIG. 2 is another perspective view of the versatile paper folder.

FIG. 3 is a cross-section view of the versatile folder taken along lines 3-3 of FIG. 1.

FIG. 4 is a simplified schematic view showing a first fold table assembly, a second fold table assembly, a first paper stop drive assembly, and a second paper stop drive assembly, and a microprocessor.

### DESCRIPTION OF THE PRESENTLY PREFERRED EMBODIMENT

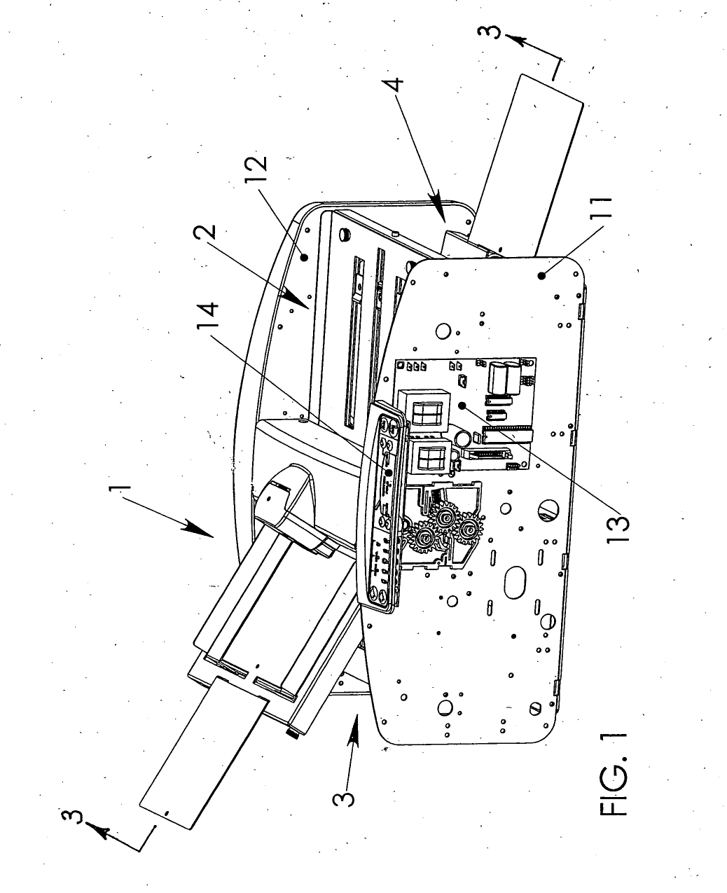

FIG. 1 is a perspective view of the versatile paper folder of the present invention. A paper feed assembly 1, a first fold table assembly 2, a second fold table assembly 3, and an exit conveyor table assembly 4 are substantially sandwiched between a front frame panel 11 and a back frame panel 12. A microprocessor 13 and means for the user input 14 are disposed on the outside of the front frame panel 11. A front cover is not shown in order to show the microprocessor 13.

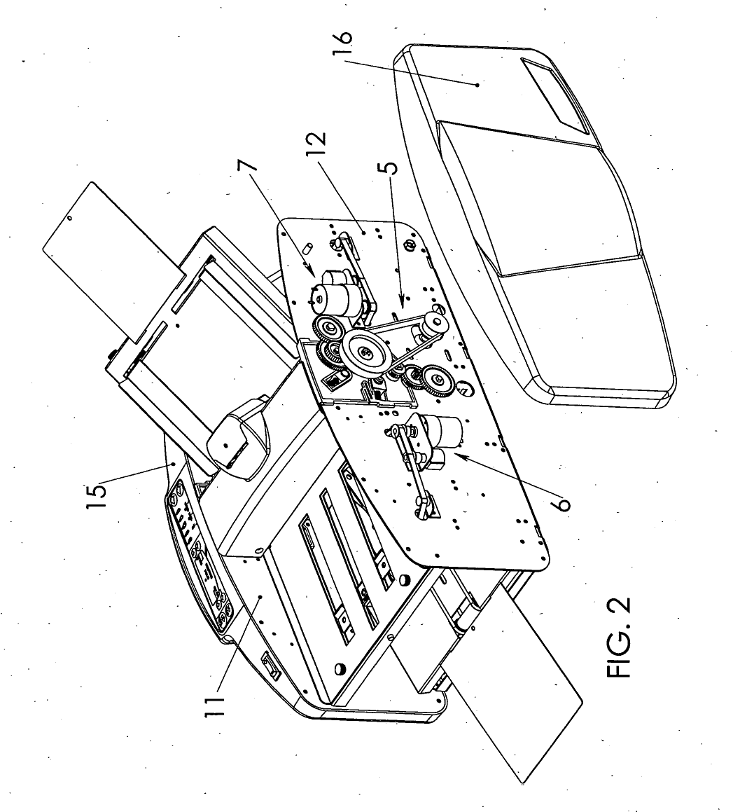

FIG. 2 is another perspective view of the versatile paper folder. A roller drive assembly 5, a first paper stop drive assembly 6, and a second paper stop drive assembly 7 are disposed substantially on the outside of the back frame panel 12.

The front cover 15 is disposed on the front panel 11 and a back cover 16 is disposed on the back panel 12. The back cover is shown detached in order to show the roller drive assembly 5, the first paper stop drive assembly 6, and the second paper drive assembly 7.

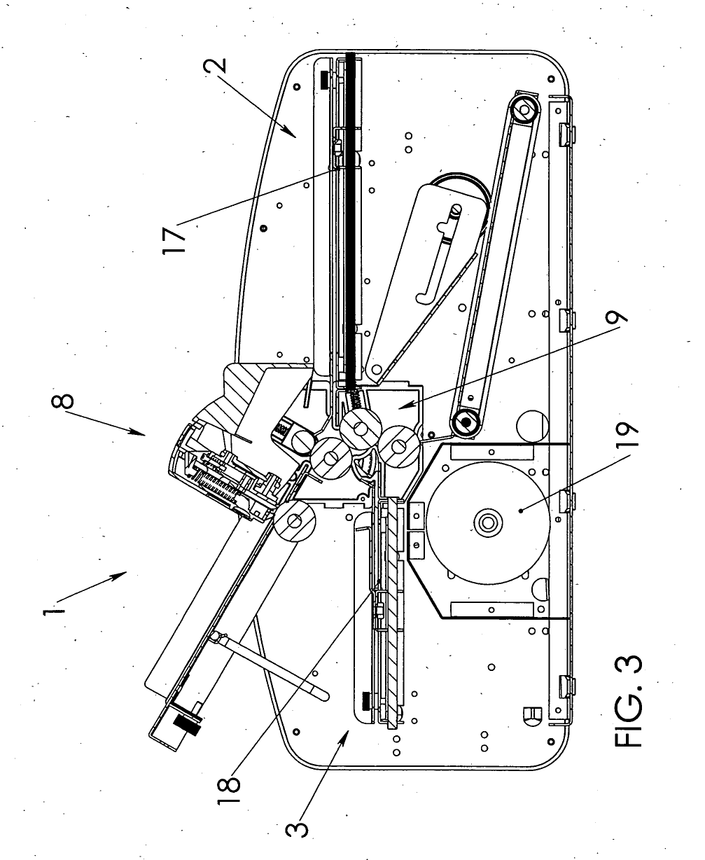

FIG. 3 is a cross-section view of the versatile folder taken along lines 3-3 of FIG. 1.

A paper control assembly 8 is disposed above the paper feed assembly 1. A first paper stop 17 is slidably disposed in the first fold table assembly 2. A second paper stop 18 is slidably disposed in the second fold table assembly 3. The roller assembly 9, substantially sandwiched between the front frame panel 11 and the back frame panel 12, is disposed under the paper control assembly 8, between the first fold table assembly 2 and the second fold table assembly 3. The roller assembly 9 employs a series of rollers to grab and move the paper being folded through the fold process and creases the paper as it passes between sets of contacting rollers. A main motor 19, disposed substantially under the rollers, drives the rollers of the roller assembly 9.

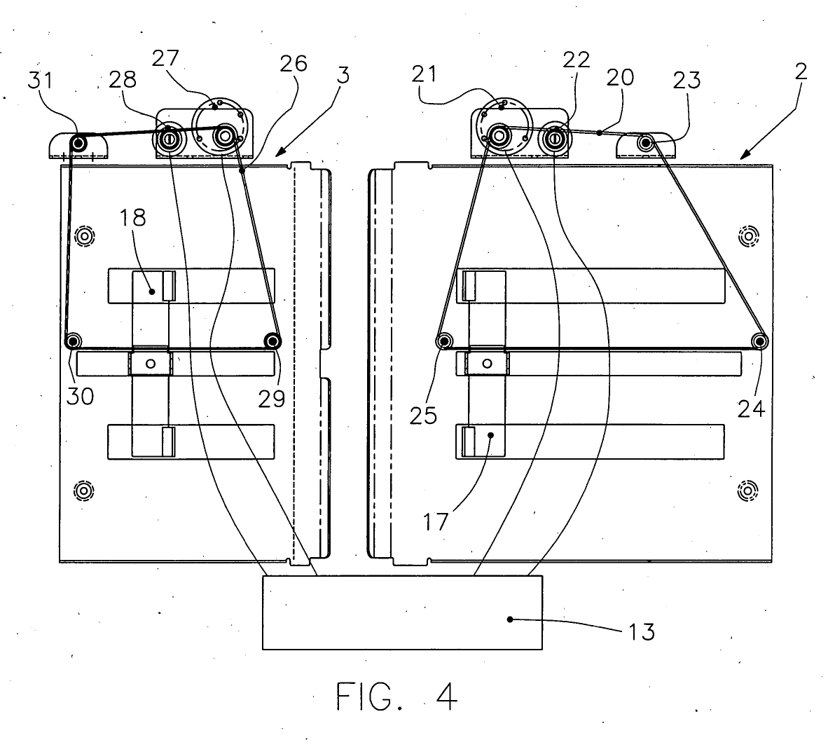

FIG. 4 is a simplified schematic view showing a first fold table assembly, a second fold table assembly, a first paper stop drive assembly, and a second paper stop drive assembly, and a microprocessor.

The first paper stop drive assembly 6 comprises the first paper stop 17, a first belt 20, a first motor 21, a first potentiometer 22, and idler wheels 23, 24, and 25 forming a first set of idler wheels.

The first paper stop 17 is attached to the first belt 20 driven by the first motor 21. The first motor 21 is electrically connected to the microprocessor 13. The first belt 20 is synchronously disposed on the idler wheels 23, 24 and 25. The first belt 20 drives the first potentiometer 22. The first potentiometer 22 is electrically connected to the microprocessor 13.

The first potentiometer 22 provides a feedback for the microprocessor 13 on the current position of the first belt 20 and the first paper stop 17. Then, the first motor 21, controlled by the microprocessor 13, drives the first belt 20 and first paper stop 17 to a new position defined by the user input.

The second paper stop drive assembly 7 comprises the second paper stop 18, a second belt 26, a second motor 27, a second potentiometer 28, and idler wheels 29, 30, and 31 forming a second set of idler wheels.

The second paper stop 18 is attached to the second belt 26 driven by the second motor 27. The second motor 27 is electrically connected to the microprocessor 13. The second belt 26 is synchronously disposed on the idler wheels 29, 30, and 31. The second belt 26 drives the second potentiometer 28. The second potentiometer 28 is electrically connected to the microprocessor 13.

The second potentiometer 28 provides a feedback for the microprocessor 13 on the current position of the second belt 26 and the second paper stop 18. Then, the second motor 27, controlled by the microprocessor 13, drives the second belt 26 and the second paper stop 18 to a new position defined by the user input.

The positioning of the first paper stop 17 and the second paper stop 18 is automatic, requiring the input from a user on the type of fold and paper, but not the user's intervention in the adjustment of the paper stops.

1. A versatile paper folder is claimed comprising:
a paper feed assembly,
a first fold table assembly,
a second fold table assembly,
an exit conveyor table assembly,
a roller drive assembly,
a first paper stop drive assembly,
a second paper drive assembly,
a paper control assembly,
a roller assembly,
a microprocessor, and
means for the user input.

2. The versatile paper folder of claim 1 wherein said first paper stop drive assembly comprises:
a first motor, the first motor electrically connected to said microprocessor,
a first potentiometer, the first potentiometer electrically connected to said microprocessor,
a first set of idler wheels, the idler wheels pivotably disposed on said first fold table assembly,
a first belt, the first belt synchronously disposed on said first motor, said first potentiometer, and said first set of idler wheels, and
a first paper stop, the first paper stop slidably disposed on said first fold table assembly fixedly to said first belt.

3. The versatile paper folder of claim 1 wherein said second paper stop drive assembly comprises:
a second motor, the second motor electrically connected to said microprocessor,
a second potentiometer, the second potentiometer electrically connected to said microprocessor,
a second set of idler wheels, the idler wheels pivotably disposed on said second fold table assembly,
a second belt, the second belt synchronously disposed on said second motor, said second potentiometer, and said second set of idler wheels, and
a second paper stop, the second paper stop slidably disposed on said second fold table assembly fixedly to said second belt.

4. A method for folding paper with the versatile paper folder comprising the following steps:
keying in a user input on the size of paper and type of desired fold,
providing an electronic feedback from said first potentiometer to said microprocessor on the current position of said first belt with said first paper stop,
activating said first motor by said microprocessor to drive said first belt with said first paper stop to a new position defined by the user input,
providing an electronic feedback from said second potentiometer to said microprocessor on the current position of said second belt and said second paper stop,
activating said second motor by said microprocessor to drive said second belt with said second paper stop to a new position defined by the user input, and
processing the paper through said roller assembly utilizing said first paper stop disposed at the new position defined by the user input,
continued processing the paper through said roller assembly utilizing said second paper stop disposed at the new position defined by the user input.
